(19) United States
(12) Patent Application Publication
(10) Pub. No.: US 2024/0146893 A1
(43) Pub. Date: May 2, 2024

(54) VIDEO PROCESSING APPARATUS, VIDEO PROCESSING METHOD AND VIDEO PROCESSING PROGRAM

(71) Applicant: Nippon Telegraph and Telephone Corporation, Tokyo (JP)

(72) Inventor: Takeru Isaka, Musashino-shi, Tokyo (JP)

(21) Appl. No.: 18/279,488

(22) PCT Filed: Mar. 5, 2021
(86) PCT No.: PCT/JP2021/008736

§ 371 Date: Aug. 30, 2023

(51) Int. Cl. H04N 13/122; H04N 13/346; H04N 13/361; H04N 13/363

(52) U.S. Cl. CPC H04N 13/122; H04N 13/346; H04N 13/361; H04N 13/363; G02B 30/56

(57) ABSTRACT

A video processing device 10 that expresses shaking in an object to be viewed on a display surface of a flat display device 22, the video processing device including: a setting unit 12 that sets a first texture with a shading change on the object to be viewed and sets a second texture with a shading change expressing an uneven surface on a part of a background video indicating a floor surface on which the object to be viewed appears to be grounded; an output unit 14 that outputs the background video surrounding the object to be viewed to the flat display device; and a control unit 13 that moves the background video, in which when the object to be viewed moves on the uneven surface of the background video, shaking of the object to be viewed is expressed by a contrast change generated in a vicinity of the object to be viewed.

### TECHNICAL FIELD

The present invention relates to a video processing device, a video processing method, and a video processing program.

### BACKGROUND ART

As disclosed in Patent Literature 1 and Non Patent Literature 1, there is known a technology of displaying a video of a display device as an aerial image by refracting or reflecting the video using an optical element such as a half mirror or a transparent plate. The aerial image is displayed on a virtual image plane in a space away from a physical device even though the aerial image is a 2D image, and thus has a feature that there are few clues for an observer to perceive that the aerial image is a flat surface as compared with the 2D image displayed on a monitor. By using this feature, it is possible to easily provide the perception of spatial localization that an object to be viewed exists at a certain position in the real space.

### CITATION LIST

### Patent Literature

Patent Literature 1: JP 2017-49354 A
Non Patent Literature
Non Patent Literature 1: Hajime Katsumoto, Hajime Kajita, Naoya Koizumi, and Takeshi Naemura. 2016. HoVerTable PONG: Playing Face-to-face Game on Horizontal Tabletop with Moving Vertical Mid-air Image. In Proceedings of the 13th International Conference on Advances in Computer Entertainment Technology (ACE '16). Association for Computing Machinery, New York, NY, USA, Article 50, 1-6. DOI: https://doi.org/10.1145/3001773.3001820

### SUMMARY OF INVENTION

### Technical Problem

When movement on a floor surface is expressed by an object to be viewed (aerial image) physically separated from the floor surface, the object to be viewed and a floor surface region where the object to be viewed appears to be grounded change depending on the viewpoint. In Patent Literature 1, in order to express the movement of the object to be viewed in the depth direction, the height of the object to be viewed in the virtual image plane is increased by perspective and separated from the floor surface.

In such a situation, when the floor surface includes an uneven surface and a flat surface, and the floor surface region where the object to be viewed appears to be grounded changes depending on the viewpoint, a shake expression applied according to the object to be viewed on the uneven surface becomes an unnatural expression with respect to the object to be viewed on the flat surface.

The present invention has been made in view of the above circumstances, and an object of the present invention is to express shaking in an object to be viewed on an uneven surface and not to express shaking in the object to be viewed on a flat surface.

### Solution to Problem

In order to achieve the above object, one aspect of the present invention is a video processing device that expresses shaking in an object to be viewed on a display surface of a flat display device, the video processing device including: a setting unit that sets a first texture with a shading change on the object to be viewed and sets a second texture with a shading change expressing an uneven surface on a part of a background video indicating a floor surface on which the object to be viewed appears to be grounded; an output unit that outputs the background video surrounding the object to be viewed to the flat display device; and a control unit that moves the background video, in which when the object to be viewed moves on the uneven surface of the background video, shaking of the object to be viewed is expressed by a contrast change generated in a vicinity of the object to be viewed.

One aspect of the present invention is a video processing method performed by a video processing device that expresses shaking in an object to be viewed on a display surface of a flat display device, the video processing method including steps of: setting a first texture with a shading change on the object to be viewed and sets a second texture with a shading change expressing an uneven surface on a part of a background video indicating a floor surface on which the object to be viewed appears to be grounded; outputting the background video surrounding the object to be viewed to the flat display device; and moving the background video in a direction opposite from a direction in which the object to be viewed is to be moved, in which when the object to be viewed moves on the uneven surface of the background video, shaking of the object to be viewed is expressed by a contrast change generated in a vicinity of the object to be viewed.

One aspect of the present invention is a video processing program for causing a computer to function as the video processing device.

### Advantageous Effects of Invention

According to the present invention, it is possible to express shaking in an object to be viewed in an uneven surface and not to express shaking in the object to be viewed in a flat surface.

### BRIEF DESCRIPTION OF DRAWINGS

FIG. 1 is a diagram for explaining a change in a positional relationship between an aerial image and a background image by changing a viewpoint.

FIG. 2A is a diagram of an aerial image expressed on a floor surface viewed from the front.

FIG. 2B is a diagram of an aerial image expressed on a floor surface viewed from right.

FIG. 3 is a configuration diagram illustrating a configuration of a display system of the present embodiment.

FIG. 4 is a diagram illustrating an example in which a vehicle moves on a floor surface including an uneven surface and a flat surface.

FIG. 5 is a diagram illustrating an example in which a vehicle moves on a floor surface including an uneven surface and a flat surface.

FIG. 6 is a diagram illustrating an example in which a yacht moves on a sea surface.

FIG. 7 is a configuration diagram illustrating a configuration of a video processing device.

FIG. 8A is a diagram illustrating a display example of an aerial image displayed on a virtual image plane and a background video projected on a screen.

FIG. 8B is a diagram illustrating a display example in which the background video in FIG. 8A is moved.

FIG. 9A is a diagram illustrating an aerial image and a background video viewed by an observer in the state of FIG. 8A.

FIG. 9B is a diagram illustrating an aerial image and a background video viewed by an observer in the state of FIG. 8B.

FIG. 10 is a flowchart illustrating a flow of processing of the video processing device.

FIG. 11 is a diagram illustrating an application example of a digital signage.

FIG. 12 is a hardware configuration example.

### DESCRIPTION OF EMBODIMENTS

Hereinafter, embodiments of the present invention will be described with reference to the drawings.

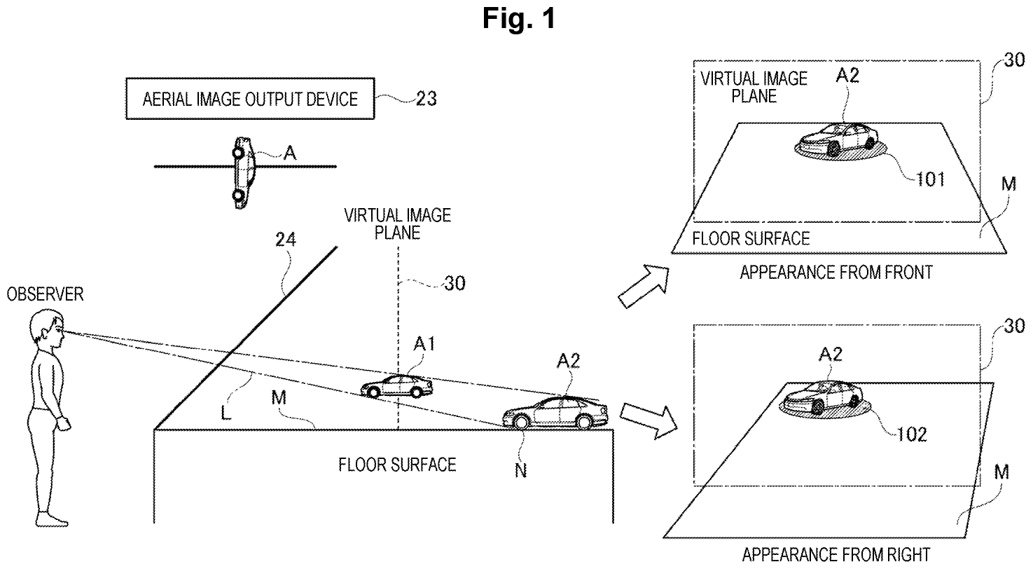

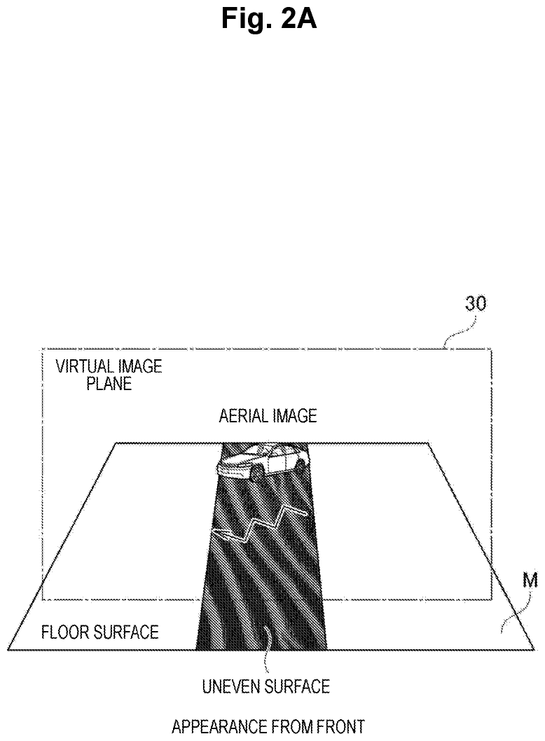

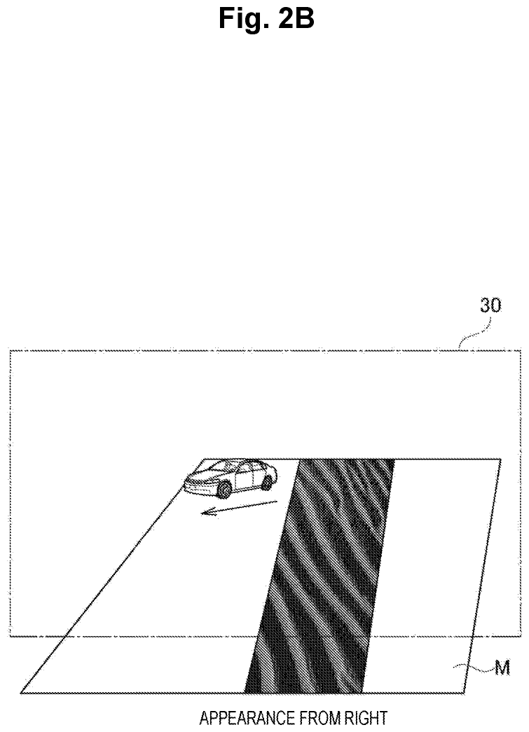

First, an outline of display of an aerial image of the present embodiment will be described with reference to FIGS. 1 and 2. In the present embodiment, an aerial image is used as an object to be viewed that is to be observed by an observer, but the present invention is not limited thereto. FIG. 1 is an explanatory diagram for explaining a change in a positional relationship between an aerial image and a background image by changing a viewpoint. In the present embodiment, an aerial image is displayed using an optical element 24 such as a half mirror. An aerial image A output from an aerial image output device 23 is displayed on a virtual image plane 30 by the optical element 24. In FIG. 1, an aerial image (object to be viewed) A displayed on the virtual image plane 30 is referred to as an aerial image A1, and an aerial image A perceived by an observer is referred to as an aerial image A2.

When the observer observes the aerial image A2, the observer perceives that a tire of a vehicle is grounded at an intersection N between a straight line L connecting the viewpoint of the observer and the tire of the aerial image A1 of the virtual image plane 30 and a floor surface M. At this time, if a display region of the tire of the vehicle on the virtual image plane 30 is physically grounded to the floor surface M, a floor surface region where the tire of the vehicle is grounded does not change even if the viewpoint of the observer changes. However, in a case where the display region of the tire of the vehicle on the virtual image plane 30 is separated from the floor surface M as illustrated in FIG. 1 (in a case where the display region is not physically grounded), when the viewpoint changes, the floor surface region where the tire of the vehicle appears to be grounded deviates.

Specifically, when viewed from the front with respect to the virtual image plane 30, the observer views that a floor surface region 101 where the tire appears to be grounded appears in the central portion of the floor surface M. On the other hand, when viewed from the right with respect to the virtual image plane 30 by the observer, a floor surface region 102 where the tire appears to be grounded appears to be shifted to the left as compared with the floor surface region 101 when viewed from the front. That is, in the half mirror type aerial image display, unless the aerial image A1 is displayed so as to be grounded on the floor surface M on the virtual image plane 30, the floor surface regions 101 and 102 where the aerial image A2 appears to be grounded change when the viewpoint is changed.

FIGS. 2A and 2B are diagrams for explaining an expression of an aerial image of the floor surface M including an uneven surface having unevenness and a flat surface. FIG. 2A illustrates a case of viewing from a front viewpoint with respect to the virtual image plane 30, and the observer views that the floor surface region where the tire appears to be grounded is on the uneven surface. FIG. 2B illustrates a case of viewing from a right viewpoint with respect to the virtual image plane 30, and the observer views that the floor surface region where the tire appears to be grounded is on the flat surface.

In this case, if a shake expression is applied to the tire of the vehicle in order to express the unevenness that the tire of the vehicle receives from the uneven surface in accordance with the viewpoint of the front of FIG. 2A, the tire appears to be on a flat surface in the viewpoint of the right side of FIG. 2B, and an unnatural expression that the tire of the vehicle shakes even though the tire is on a flat surface is obtained.

That is, in a case where a part of the floor surface M has an uneven surface, if an uneven expression in which the tire is shaking so as to be aligned with the viewpoint of the front is simply applied to the aerial image, an inconsistent expression in which the tire appears to shake even though the tire is on a flat surface when viewed from the right is obtained.

In the present embodiment, the unevenness received from the floor surface when the aerial image moves on the floor surface is expressed so as to be matched at each viewpoint. Specifically, by using an optical illusion of perceiving shaking of an object only on a floor surface having a texture pattern simulating an uneven surface without physically shaking an aerial image, a problem of expression mismatch caused by a deviation between a plurality of viewpoints in the aerial image and a background (floor surface) thereof is solved. Specifically, in FIG. 2A, an expression of moving while shaking the tire is used to show the unevenness, and in FIG. 2B, an expression of moving without shaking the tire is used.

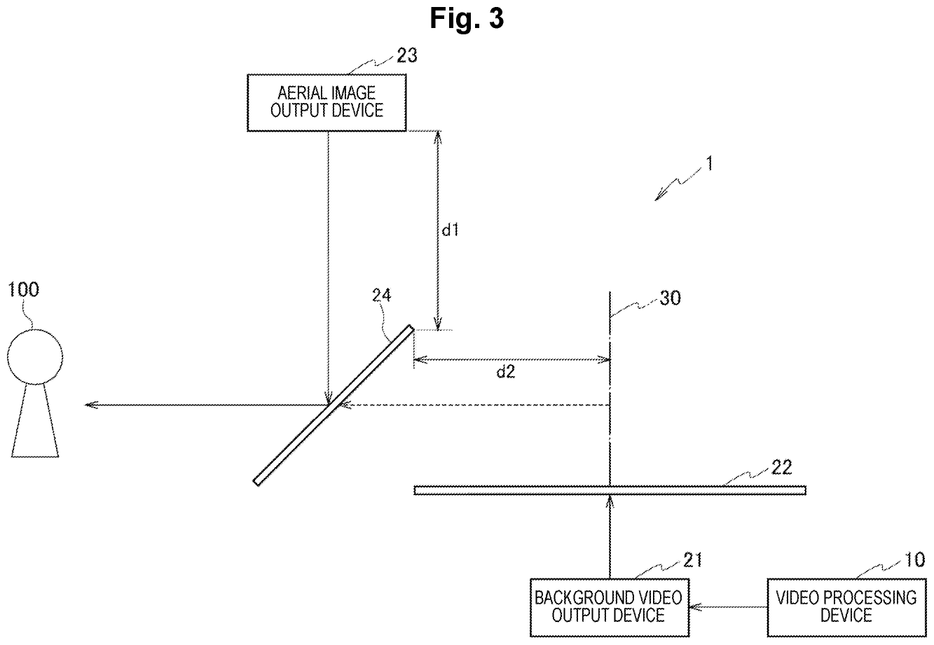

FIG. 3 is a configuration diagram illustrating a configuration of a display system 1 of the present embodiment. The illustrated display system 1 includes a video processing device 10, a background video output device 21, a screen 22 (flat display device), an aerial image output device 23, and an optical element 24.

The display system 1 displays an aerial image (object to be viewed) on the virtual image plane 30 by the aerial image output device 23 and the optical element 24, and causes the displayed aerial image to be perceived as moving in a background video projected on the screen 22. Specifically, for example, under a dark room condition, the display system 1 causes an observer 100 to perceive that the object to be viewed is moving in the depth direction or the front direction. The dark room condition is an environment in which the amount of ambient light surrounding the display system 1 and the observer is small, and it is desirable that the surrounding devices are not visible.

The screen 22 is disposed parallel to the ground. The background video output device 21 projects a background video onto the screen 22. The background video output device 21 may project a video from any direction.

The optical element 24 (for example, a half mirror) is disposed to be inclined by about 45 degrees, and the aerial image output device 23 is disposed above or below the optical element 24. The video output by the aerial image output device 23 is reflected by the optical element 24 in the direction of the observer 100, and forms an aerial image that is the object to be viewed on the virtual image plane 30.

The screen 22 and the optical element 24 are disposed such that virtual image plane 30 is parallel to the normal direction of the screen 22. A distance d2 from the optical element 24 to the virtual image plane 30 can be adjusted by changing a distance d1 from the aerial image output device 23 to the optical element 24. The shorter the distance d1, the shorter the distance d2. In the present embodiment, the aerial image output device 23 is disposed such that the virtual image plane 30 is in the vicinity of the center of the screen 22. The position of the virtual image plane 30 is not limited to the center of the screen 22, and may be disposed in any position. The positions of the aerial image output device 23 and the optical element 24 may be fixed.

The aerial image output device 23 and the optical element 24 only need to be able to display an aerial image above the screen 22, and are not limited to the above configuration. The aerial image is not necessarily displayed as floating in the air, and may be displayed as being grounded on a display surface (floor surface) of the screen 22. Alternatively, the screen 22 may be disposed above, and the aerial image may be displayed so as to hang on the background video displayed on the screen 22. In the present embodiment, the aerial image is displayed so as to be in contact with the floor surface of the background video.

Instead of displaying the aerial image by the aerial image output device 23 and the optical element 24, a transparent screen may be arranged on the screen 22, and a video projected on the transparent screen may be set as an object to be viewed. Alternatively, a real object may be arranged on the screen 22, and the real object may be set as an object to be viewed. The positions of the transparent screen and the real object may be fixed.

The video processing device 10 supplies the background video that causes the aerial image to perform the guiding motion to the background video output device 21. Specifically, the video processing device 10 moves the background video in a direction opposite to the moving direction of the aerial image to cause the aerial image to perform the guiding motion. The guiding motion is an illusion phenomenon that gives motion perception to a stationary object. The background video that causes the guiding motion is a video surrounding the aerial image when viewed from the viewpoint of observer 100. In the present embodiment, the floor surface representing the movement range of the aerial image is used as a background video, and the aerial image is perceived as moving on the floor surface. Descriptions of the guiding motion will be given later.

The video processing device 10 switches the presence or absence of the unevenness of the aerial image according to the background by the optical illusion. The human visual system has a visual characteristic of perceiving a change in brightness even if the physical brightness is the same when the contrast changes. In the present embodiment, a shading change is applied to the texture (first texture) of the aerial image using the human visual characteristics. Only in a case where the aerial image appears to move on the background to which the texture (second texture) having a shading change is imparted, the video processing device 10 allows a pseudo edge change due to a contrast change between the aerial image and the background image to be perceived in the vicinity of the aerial image, thereby expressing the unevenness.

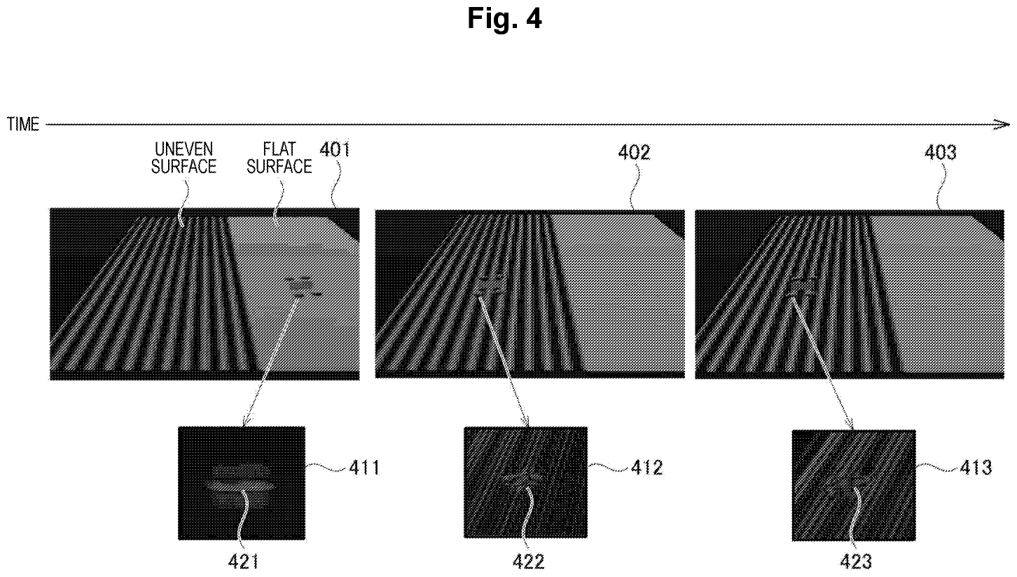

FIG. 4 illustrates an example in which a vehicle moves on a floor surface including an uneven surface and a flat surface. Here, the floor surface includes a flat surface (texture with no shading change) and an uneven surface (texture with a shading change). In the vehicle in the aerial image, a texture with a shading change is set in a shaking portion (here, a tire of the vehicle) where shaking is desired to be expressed. In the illustrated example, the upper part of the tire is light and the lower part of the tire is dark.

In this case, the video processing device 10 causes a guiding motion in which the vehicle appears to move from the flat surface of the floor surface of the background video toward the uneven surface. When the tire (shaking portion) with the shading change in the aerial image moves on the floor surface of the uneven surface, the contrast between the tire and the floor surface behind the tire changes from moment to moment. At this time, the observer perceives a pseudo edge due to the contrast change in the vicinity of the tire. By using this visual characteristic, the observer feels the shaking of the tire without physically shaking the tire. The observer sees the tire shaking on the uneven surface, but does not see the tire shaking on the flat surface.

An image 401 is an image in a case where a vehicle is moving on a flat surface. A pseudo edge (thin black line) 421 displayed on a contrast-enhanced image 411 near the tire does not change as long as the pseudo edge moves on the flat surface. The pseudo edge is generated by a contrast change.

On the other hand, images 402 and 403 are images of a case where a vehicle is moving on an uneven surface. An image 412 is a contrast-enhanced image near the tire of the image 402. An image 413 is a contrast-enhanced image near the tire of the image 403. The pseudo edge 422 of the contrast-enhanced image 412 at a certain time point is different from the pseudo edge 423 of the contrast-enhanced image 413 thereafter. That is, on the uneven surface, the pseudo edge changes from moment to moment with movement. As described above, when the vehicle moves on the uneven surface, the contrast between the tire and the floor surface changes from moment to moment in the vicinity of the tire of the aerial image to which the texture having the shading change is imparted, and the observer perceives the change in the pseudo edges 422 and 423 due to the contrast change as the shake of the tire.

The floor surface may be not only a floor of a building or the like but also a ground surface, a water surface (for example, a sea surface, a lake surface, a river surface, or the like), or a combination thereof. That is, the floor surface of the present embodiment may include at least one of the floor, the ground, and the water surface. The aerial image and the floor surface (background video) may be monochrome or color.

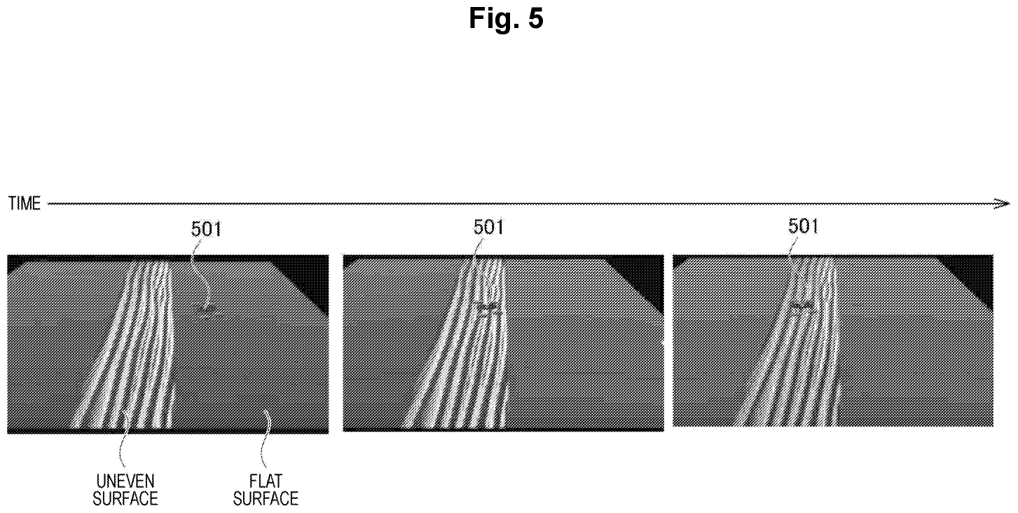

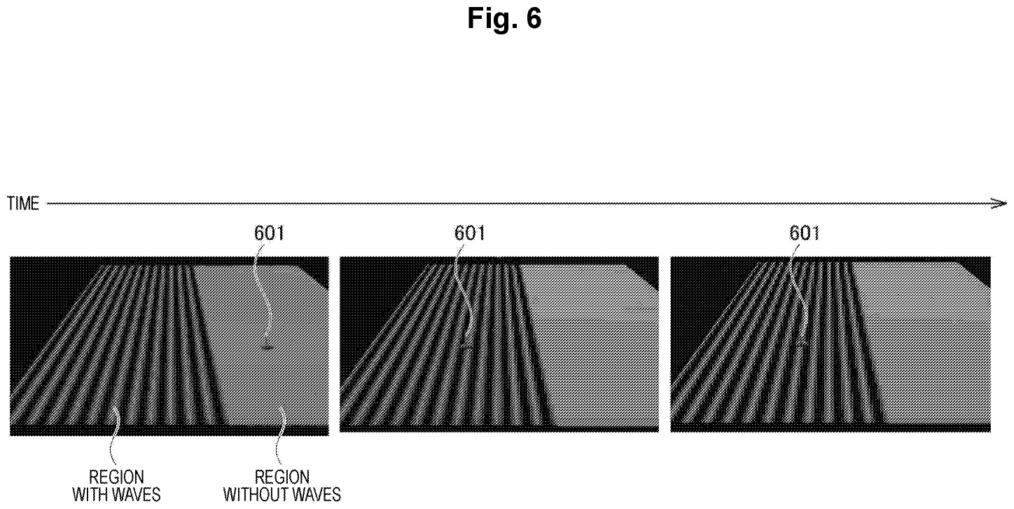

FIGS. 5 and 6 illustrate examples of the aerial image and the floor surface in color. In the drawings, the aerial image and the floor surface are represented by black and white monotones. The aerial image and the floor surface in FIGS. 5 and 6 are monochrome, and a texture having a shading change of monochrome may be set.

FIG. 5 is a diagram illustrating an example in which a vehicle 501 (aerial image) moves on the ground including an uneven surface and a flat surface. In the uneven surface of the ground and the tire of the vehicle in FIG. 5, a texture having a shading change is set. Also in FIG. 5, as similar to FIG. 4, the tire appears to shake on the uneven surface, but the tire shaking is not seen on the flat surface.

FIG. 6 illustrates an example in which a yacht 601 (aerial image) moves on a sea surface including a region with waves and a region without waves. In the region having waves and the yacht 601 of FIG. 6, a texture with a color shading change is set. To the illustrated yacht 601, a texture with a shading change in the entire yacht 601 is applied, and the video processing device 10 expresses the entire yacht 601 as if it shakes in a region with waves. In the region without waves, the yacht 601 appears to be not shaken.

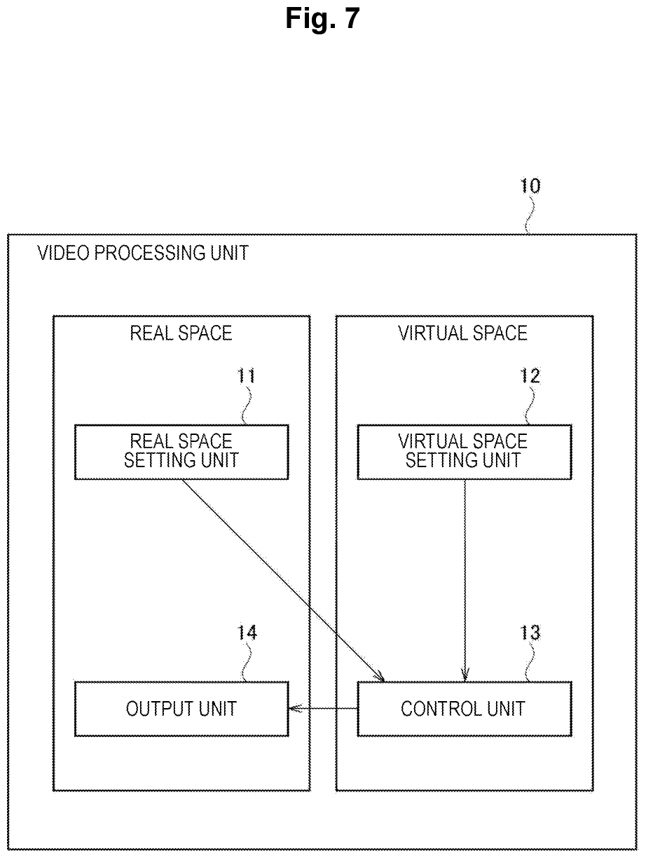

FIG. 7 is a configuration diagram illustrating a configuration of the video processing device 10. The video processing device 10 expresses shaking in the aerial image (object to be viewed) on the display surface of screen 22. The illustrated video processing device 10 includes a real space setting unit 11, a virtual space setting unit 12, a control unit 13, and an output unit 14.

The real space setting unit 11 installs the aerial image output device 23 and the optical element 24 in the real space such that an upright aerial image (aerial image object) is generated on the virtual image plane 30. The screen 22 capable of displaying an image spreading in the normal direction of the virtual image plane 30 is installed.

The virtual space setting unit 12 (setting unit) sets a first texture with a shading change in the aerial image, and sets a second texture with a shading change representing the uneven surface in a part of the background video indicating the floor surface on which the aerial image appears to be grounded. That is, in order to cause the observer to have an optical illusion, the virtual space setting unit 12 applies a first texture having a shading change to the aerial image to be shaken and shown, and partially applies a second texture having a shading change imitating an uneven surface to the floor surface. As a result, when the aerial image moves on the uneven surface of the background video, the shake of the aerial image is expressed by the contrast change generated in the vicinity of the aerial image.

The virtual space setting unit 12 may set the first texture having a shading change in the entire aerial image, and express the shaking of the entire aerial image by a contrast change generated in the vicinity of the entire aerial image when the aerial image moves on the uneven surface of the background video. Alternatively, the virtual space setting unit 12 may set the first texture in a shaking portion expressing the shaking of the aerial image, and express the shaking of the shaking portion of the aerial image by a contrast change generated in the vicinity of the shaking portion when the aerial image moves on the uneven surface of the background video.

The virtual space setting unit 12 may adjust the amount of shaking (the fineness of shaking) and the frequency of shaking with the brightness of the uneven surface of the floor surface and the spatial frequency.

The virtual space setting unit 12 arranges the aerial image and the floor surface in the virtual space such that the positional relationship between the aerial image in the virtual image plane and the actual floor surface is equal. The positional relationship between the aerial image in the virtual space and the virtual camera lens for the aerial image is made equal to the positional relationship between the aerial image displayed on the virtual image plane and the viewpoint of the observer in front.

For example, the virtual space setting unit 12 arranges the aerial image object representing the aerial image in the virtual space and the floor surface object serving as the background video at the initial positions on the basis of the positional relationship between the aerial image in the real space and the screen 22. For example, the virtual space setting unit 12 arranges the floor surface object such that the aerial image object stands near the center of the floor surface object. The floor surface object is a flat surface figure indicating a movement range of the aerial image object.

The virtual space setting unit 12 arranges, in the virtual space, a virtual camera for a background for capturing a video to be projected on the screen 22. The virtual camera for the background captures an image of a region including the floor surface object. A video captured by the virtual camera for the background is projected on the screen 22. When the floor surface object is moved in the virtual space while the position of the virtual camera is fixed, the background video projected on the screen 22 moves.

The virtual space setting unit 12 may arrange a virtual camera for an aerial image that captures an aerial image object. The virtual camera for an aerial image captures an aerial image object from a lateral direction. The aerial image output device 23 projects a video captured by the virtual camera for an aerial image onto the optical element 24, and displays the aerial image on the virtual image plane. The virtual camera for the aerial image may be set to an imaging method by perspective projection. The capturing results of the virtual camera for the aerial image and the virtual camera for the background are respectively reflected on the image of the virtual image plane and the image of the actual floor surface in real time.

The control unit 13 moves the background video and moves the aerial image in the virtual space. In the present embodiment, the control unit 13 moves the floor surface (background video) in a direction opposite to a direction in which the aerial image is desired to be moved, thereby causing the aerial image to perform the guiding motion.

Specifically, the control unit 13 moves the floor surface object on the basis of the movement amount of the aerial image object. For example, in a case where it is desired to move the aerial image in the front direction by a distance v, the control unit 13 moves the floor surface object in the depth direction by the distance v. That is, the control unit 13 moves only the floor surface object and does not move the aerial image object, the virtual camera for the aerial image, and the virtual camera for the background. Alternatively, the control unit 13 may move the aerial image object, the virtual camera for the aerial image, and the virtual camera for the background in the same direction by the same movement amount without moving the floor surface object. In either case, when the floor surface object is moved, the position where the floor surface object appears in the video captured by the virtual camera for the background moves.

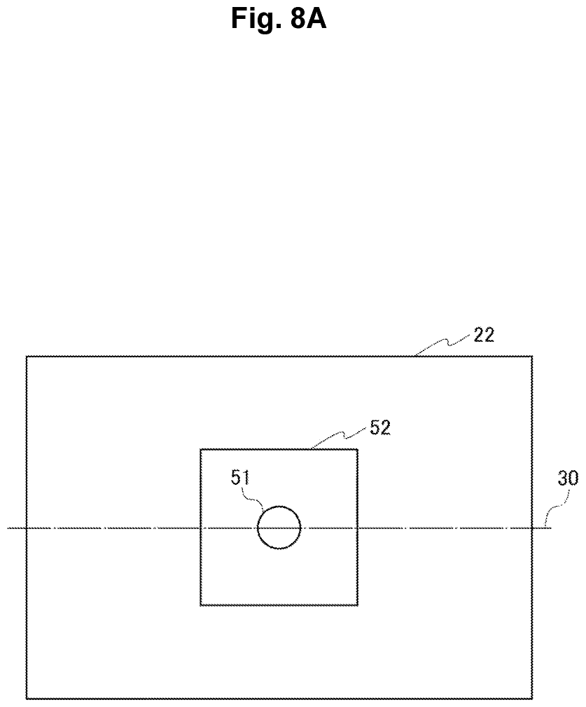

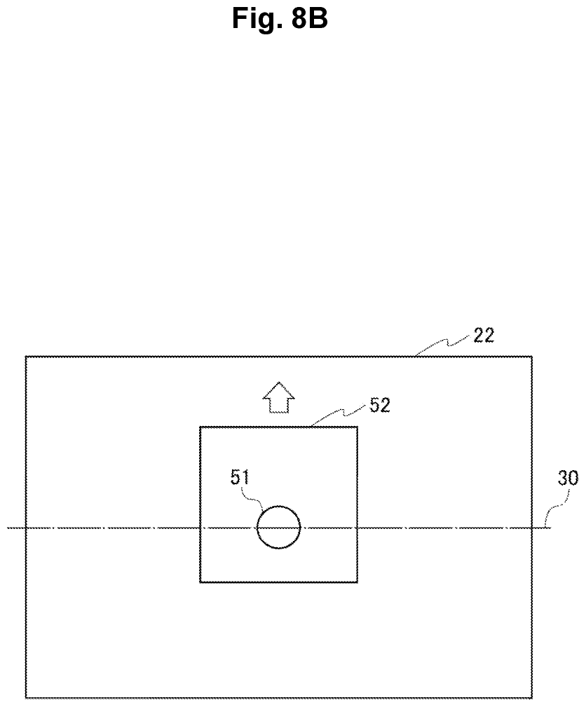

FIG. 8A illustrates a display example of the aerial image 51 displayed on the virtual image plane 30 and the background video 52 projected on the screen 22. FIG. 8A is a top view of the screen 22 in FIG. 4. It is assumed that the observer is in a downward direction on the drawing. The aerial image 51 is projected onto the virtual image plane 30, and in FIG. 8A, the position where the aerial image 51 is displayed is represented by a circle. The background video 52 is a video of a floor surface, the ground, or the like surrounding the aerial image 51. The shape, pattern, and color of the background video 52 can be arbitrarily set. Nothing is displayed on the outside of the background video 52, and the outside part is in a completely dark state.

FIG. 8B is a display example when the background video 52 is moved upward in the drawing, that is, toward the back side as viewed from the observer from the state of FIG. 8A. The display position of the aerial image 51 is not moved. The aerial image 51 moves downward with reference to the background video 52. In a case where an environment in which the display system 1 is installed is bright and an object, such as a frame of the screen 22 or a peripheral device, whose position of the background video 52 in the real space can be seen, the observer perceives that the background video 52 is moving.

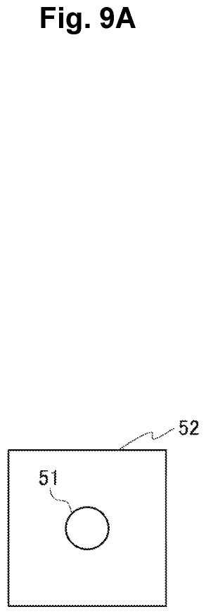

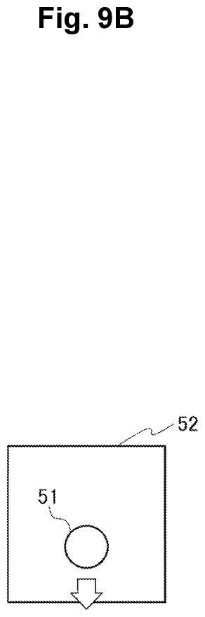

Under the dark room condition, as illustrated in FIGS. 9A and 9B, the observer gazes at only the aerial image 51 and the background video 52. When moving the background video 52, the observer perceives that the aerial image 51 is moving although the background video 52 is moving in actual, as illustrated in FIG. 9B. That is, by moving the background video 52 surrounding the aerial image 51 under the dark room condition, it is possible to spatially localize the aerial image 51 as if the aerial image has moved to an arbitrary position in the background video 52.

When the aerial image can freely move in the virtual image plane, the control unit 13 may move the background video 52 only in the normal direction of the virtual image plane. For example, in the example illustrated in FIG. 8A, when the aerial image 51 moves in the horizontal direction along the virtual image plane, the background video 52 is not moved. When the object to be viewed 51 moves in the vertical direction in FIG. 8A, the background video 52 is moved in accordance with the moving amount of the aerial image 51 in the vertical direction.

The control unit 13 may change the size and height of the aerial image according to the movement amount in the depth direction by perspective projection.

The output unit 14 outputs the background video surrounding the aerial image to the screen 22. Specifically, the output unit 14 outputs a video including the aerial image object captured by the virtual camera for an aerial image to the aerial image output device 23. The output unit 14 outputs the video including the floor surface object captured by the virtual camera for the background to the background video output device 21.

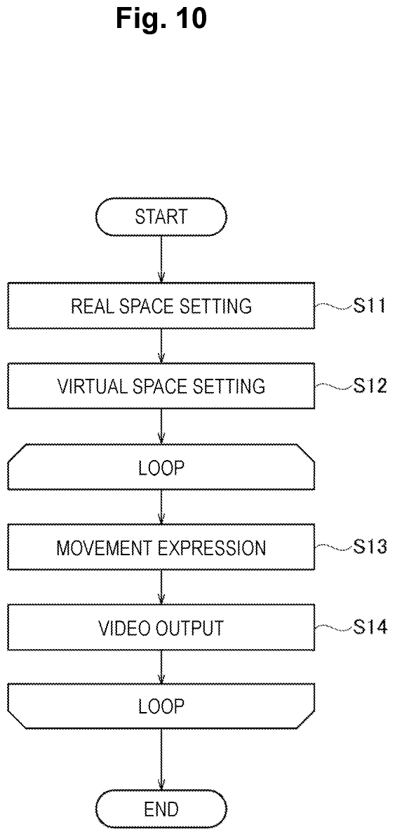

The operation of the video processing device 10 will be described with reference to the flowchart of FIG. 10.

In step S11, the real space setting unit 11 installs the aerial image output device 23 and the optical element 24 in the real space such that an upright aerial image (aerial image object) is generated on the virtual image plane 30. The screen 22 capable of displaying an image spreading in the normal direction of the virtual image plane 30 is installed.

In step S12, the virtual space setting unit 12 arranges the floor surface object at the initial position in the virtual space and arranges the virtual camera that captures the floor surface object on the basis of the positional relationship between the aerial image in the real space and the screen 22. The virtual space setting unit 12 arranges the aerial image and the virtual camera for the aerial image in the virtual space. The virtual space setting unit 12 sets a first texture with a shading change in the aerial image, and sets a second texture with a shading change representing the uneven surface in a part of the background video indicating the floor surface on which the aerial image appears to be grounded.

In step S13, the control unit 13 calculates the movement amount of one frame of the floor surface on the basis of the movement amount of one frame of the object to be viewed, and moves the floor surface object according to the calculated movement amount.

In step S14, the output unit 14 outputs the background video obtained by capturing the flat surface including the floor surface object with the virtual camera to the background video output device 21. The output unit 14 outputs a video obtained by capturing the aerial image object by the virtual camera for an aerial image to the aerial image output device 23.

The processing of steps S13 and S14 is performed for each frame.

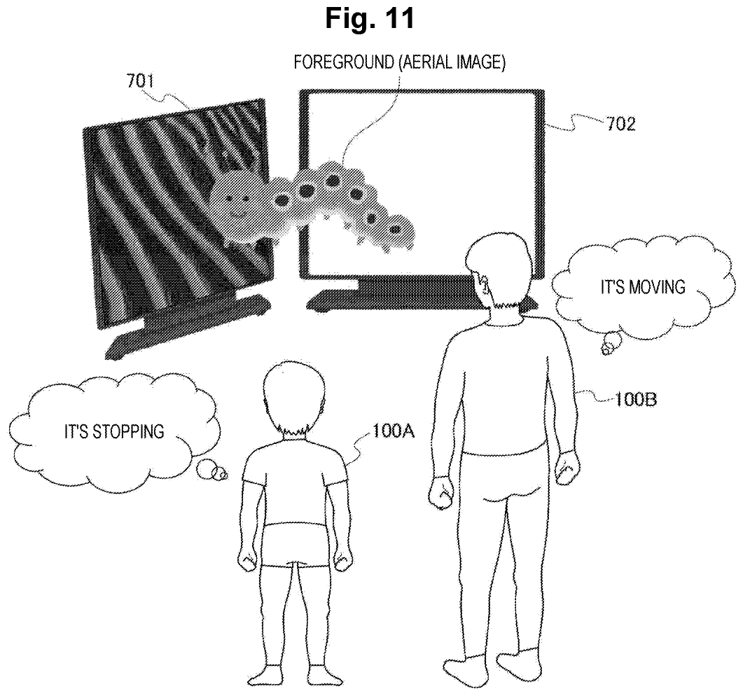

FIG. 11 is a diagram illustrating an application example in which the display system of the present embodiment is applied to a digital signage in which the display content changes depending on the viewpoint viewed by the observer. In the illustrated example, the aerial image (object to be viewed) serving as the foreground is a caterpillar, and a texture with a shading change is applied to a lower portion (shaking portion) of the caterpillar.

In this case, an observer 100A views the screen 702 in which the texture (flat surface) without the shading change is displayed as the background. To the observer 100A, the aerial image that is the foreground appears to be stopped. On the other hand, an observer 100B is viewing a screen 701 on which a texture (uneven surface) having a shading change is displayed as a background. To the observer 100B, the aerial image that is the foreground appears to be moving while shaking.

A video processing device 10 of the present embodiment as described above that expresses shaking in an aerial image (an object to be viewed) on a display surface of a screen 22, the video processing device 10 including: a virtual space setting unit 12 that sets a first texture with a shading change on the aerial image and sets a second texture with a shading change expressing an uneven surface on a part of a background video indicating a floor surface on which the aerial image appears to be grounded; an output unit 14 that outputs the background video surrounding the aerial image to the screen 22; and a control unit 13 that moves the background video, in which when the aerial image moves on an uneven surface of the background video, shaking of the aerial image is expressed by a contrast change generated in a vicinity of the aerial image.

As described above, in the present embodiment, the observer perceives the pseudo edge change due to the contrast change between the aerial image and the background in the vicinity of the aerial image, thereby expressing the unevenness of the floor surface. As a result, in the present embodiment, by causing the user to feel that the aerial image shakes only when there is an image having a texture with a shading change in the background without physically shaking the aerial image, it is possible to simultaneously achieve an expression of moving while shaking the aerial image on the texture with the shading change (uneven surface) and an expression of moving without shaking the aerial image on the texture without the shading change (flat surface). That is, the unevenness that the object to be viewed viewed from a certain viewpoint receives from the floor surface of the background can be expressed without discomfort even when observed from a plurality of viewpoints.

In the present embodiment, a pseudo edge change due to a contrast change is perceived by an observer without physically shaking the aerial image, so that the observer feels as if the aerial image is shaking. Therefore, in the present embodiment, it is not necessary to express the shaking by moving the vertex of the polygon model in the CG representation, and the shaking can be easily expressed at low cost.

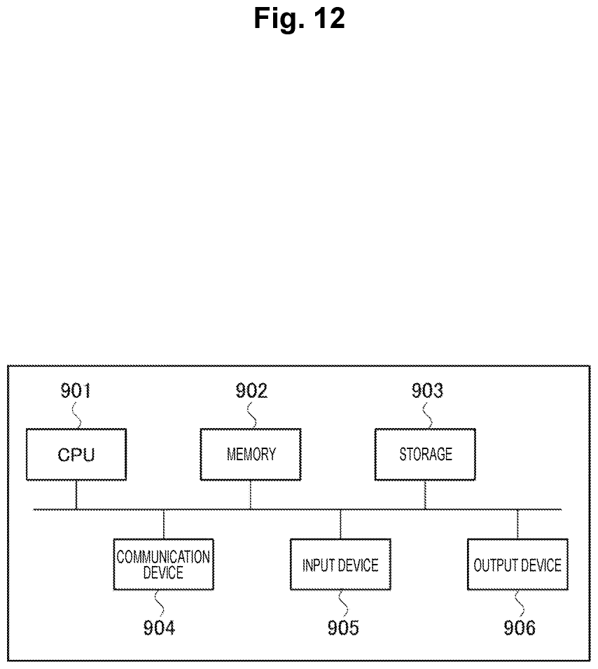

For the above-described video processing device 10, for example, a general-purpose computer system as illustrated in FIG. 12 can be used. The illustrated computer system includes a central processing unit (CPU, processor) 901, a memory 902, a storage 903, a communication device 904, an input device 905, and an output device 906. The memory 902 and the storage 903 are storage devices. In the computer system, each function of the video processing device 10 is implemented by the CPU 901 executing a predetermined program loaded on the memory 902.

Note that the video processing device 10 may be implemented by one computer, or may be implemented by a plurality of computers. In addition, the video processing device 10 may be a virtual machine that is implemented in a computer. The program of the video processing device 10 can be stored in a computer-readable recording medium such as a hard disk drive (HDD), a solid state drive (SSD), a universal serial bus (USB) memory, a compact disc (CD), or a digital versatile disc (DVD), or can be distributed via a network.

Note that the present invention is not limited to the above embodiment, and various modifications can be made within the scope of the gist of the present invention. In the above embodiment, the aerial image is used as the object to be viewed, but the object to be viewed is not limited to the aerial image and can be generally applied to visual stimulation. For example, the moving object to be viewed and the floor surface may be made of paper or the like.

### REFERENCE SIGNS LIST

1 Display system
10 Video processing device
11 Real space setting unit
12 Virtual space setting unit (setting unit)
13 Control unit
14 Output unit
21 Background video output device
22 Screen (flat display device)
23 Aerial image output device
24 Optical element
30 Virtual image plane
100 Observer

1. A video processing device that expresses shaking in an object to be viewed on a display surface of a flat display device, the video processing device comprising one or more processors configured to:
set a first texture with a shading change on the object to be viewed and set a second texture with a shading change expressing an uneven surface on a part of a background video indicating a floor surface on which the object to be viewed appears to be grounded;
output the background video surrounding the object to be viewed to the flat display device; and
move the background video,
wherein when the object to be viewed moves on the uneven surface of the background video, shaking of the object to be viewed is expressed by a contrast change generated in a vicinity of the object to be viewed.

2. The video processing device according to claim 1,
wherein the object to be viewed is an aerial image.

3. The video processing device according to claim 1, configured to:
set a first texture in a shaking portion expressing shaking of the object to be viewed, and
express shaking of the shaking portion by the contrast change generated in a vicinity of the shaking portion when the object to be viewed moves on the uneven surface of the background video.

4. The video processing device according to claim 1,
wherein the floor surface includes at least one of a floor, a ground, and a water surface.

5. The video processing device according to claim 1, configured to:
use brightness of the uneven surface and a spatial frequency to adjust an amount of shaking of the object to be viewed and a frequency of shaking.

6. A video processing method performed by a video processing device that expresses shaking in an object to be viewed on a display surface of a flat display device, the video processing method comprising:
setting a first texture with a shading change on the object to be viewed and setting a second texture with a shading change expressing an uneven surface on a part of a background video indicating a floor surface on which the object to be viewed appears to be grounded;
outputting the background video surrounding the object to be viewed to the flat display device; and
moving the background video in a direction opposite from a direction in which the object to be viewed is to be moved,
wherein when the object to be viewed moves on the uneven surface of the background video, shaking of the object to be viewed is expressed by a contrast change generated in a vicinity of the object to be viewed.

7. A non-transitory computer readable medium storing one or more instructions for causing a computer to execute:
setting a first texture with a shading change on an object to be viewed and setting a second texture with a shading change expressing an uneven surface on a part of a background video indicating a floor surface on which the object to be viewed appears to be grounded;
outputting the background video surrounding the object to be viewed to a flat display device; and
moving the background video in a direction opposite from a direction in which the object to be viewed is to be moved,
wherein when the object to be viewed moves on the uneven surface of the background video, shaking of the object to be viewed is expressed by a contrast change generated in a vicinity of the object to be viewed.

8. The video processing method according to claim 6,
wherein the object to be viewed is an aerial image.

9. The video processing method according to claim 6, comprising:
setting a first texture in a shaking portion expressing shaking of the object to be viewed; and
expressing shaking of the shaking portion by the contrast change generated in a vicinity of the shaking portion when the object to be viewed moves on the uneven surface of the background video.

10. The video processing method according to claim 6,
wherein the floor surface includes at least one of a floor, a ground, and a water surface.

11. The video processing method according to claim 6, comprising:
using brightness of the uneven surface and a spatial frequency to adjust an amount of shaking of the object to be viewed and a frequency of shaking.

12. The non-transitory computer readable medium according to claim 7,
wherein the object to be viewed is an aerial image.

13. The non-transitory computer readable medium according to claim 7, wherein the one or more instructions cause the computer to execute:
setting a first texture in a shaking portion expressing shaking of the object to be viewed; and
expressing shaking of the shaking portion by the contrast change generated in a vicinity of the shaking portion when the object to be viewed moves on the uneven surface of the background video.

14. The non-transitory computer readable medium according to claim 7,
wherein the floor surface includes at least one of a floor, a ground, and a water surface.

15. The non-transitory computer readable medium according to claim 7, wherein the one or more instructions cause the computer to execute:
using brightness of the uneven surface and a spatial frequency to adjust an amount of shaking of the object to be viewed and a frequency of shaking.
